(19) United States
(12) Patent Application Publication
(10) Pub. No.: US 2015/0160707 A1
(43) Pub. Date: Jun. 11, 2015

(54) PORTABLE ELECTRONIC DEVICE

(71) Applicant: HTC Corporation, Taoyuan City (TW)

(72) Inventors: Hsiu-Hung CHOU, Taoyuan City (TW); Chia-Lin CHANG, Taoyuan City (TW)

(73) Assignee: HTC Corporation, Taoyuan City (TW)

(21) Appl. No.: 14/099,492

(22) Filed: Dec. 6, 2013

(51) Int. Cl. G06F 1/32

(52) U.S. Cl. CPC G06F 1/3203; G06F 1/324

(57) ABSTRACT

A portable electronic device comprising a storage unit, an application processor and a wireless communication chip is provided. The storage unit stores multimedia data. The application processor coupled to the storage unit accesses the multimedia data stored in the storage unit and executes at least one application program. The wireless communication chip includes a WiFi/WiMax module and a digital signal processor integrated thereinto. The WiFi/WiMax module is configured to receive an audio stream data from a remote station, and the digital signal processor is configured to process the audio stream data from the WiFi/WiMax module or the multimedia data from the application processor and generate an audio output signal according to the processed audio stream data or the processed multimedia data. The wireless communication chip is configured to output the audio output signal.

### BACKGROUND OF THE INVENTION

1. Field of the Invention

The invention relates to a portable electronic device, and more particularly, to a portable electronic device for playing audio signals.

2. Description of the Related Art

To keep up with the bustling pace of modern human living, a variety of portable electronic devices which are compact have been developed. Taking portable communication devices such as a smartphone for example, it is not only equipped with all the functions of a traditional communication device, but it also allows users to achieve purposes such as writing documents, receiving and sending e-mails, surfing the internet, playing multimedia files or communicating by instant message software through various applications of an operating system built therein. In other words, the portable communication device not only can be used for making phone calls, but also has all kinds of diversified functions like a small personal computer.

A portable electronic device with multiple functions may have an audio output apparatus used to provide audio output and a display used to display images and information of the multiple functions. When a portable electronic device is operated, various application programs, such as a video and audio player program, a video game program and a real-time speech communication program for establishing speech communication on a computer network, can be executed by a processor.

In a conventional portable electronic device, a central processing unit (CPU) has a digital signal processor (DSP) integrated thereinside and is used to perform algorithms of coding and decoding for audio signals. Therefore, when a multimedia file (e.g. an mp3 file) is played, the DSP has to perform the application programs corresponding to the multimedia file, thereby the CPU is also enabled to perform the corresponding application programs. Furthermore, when a wireless communication module (e.g. WiFi) of the conventional portable electronic device is enabled to perform the application programs corresponding to the multimedia files, loading of the DSP is increased and the power consumption of the CPU is also increased in the conventional portable electronic device.

Therefore, it is important to decrease power consumption while a portable electronic device plays multimedia data.

### BRIEF SUMMARY OF THE INVENTION

A portable electronic device is provided. An embodiment of a portable electronic device comprises: a storage unit configured to store multimedia data; an application processor coupled to the storage unit and configured to access the multimedia data stored in the storage unit and execute at least one application program; a first antenna; and a wireless communication chip comprising a WiFi/WiMax module and a digital signal processor (DSP) integrated thereinto. The WiFi/WiMax module is coupled to the first antenna for wirelessly receiving an audio stream data from a remote station, and the digital signal processor is coupled to the WiFi/WiMax module and the application processor and configured to process the audio stream data from the WiFi/WiMax module or the multimedia data from the application processor and generate an audio output signal according to the processed audio stream data or the processed multimedia data. The wireless communication chip is configured to output the audio output signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic diagram illustrating a portable electronic device according to an embodiment of the invention;

FIG. 2 shows a schematic diagram illustrating a portable electronic device according to another embodiment of the invention;

FIG. 3 shows a schematic diagram illustrating a portable electronic device according to another embodiment of the invention; and

FIG. 4 shows a schematic diagram illustrating a portable electronic device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

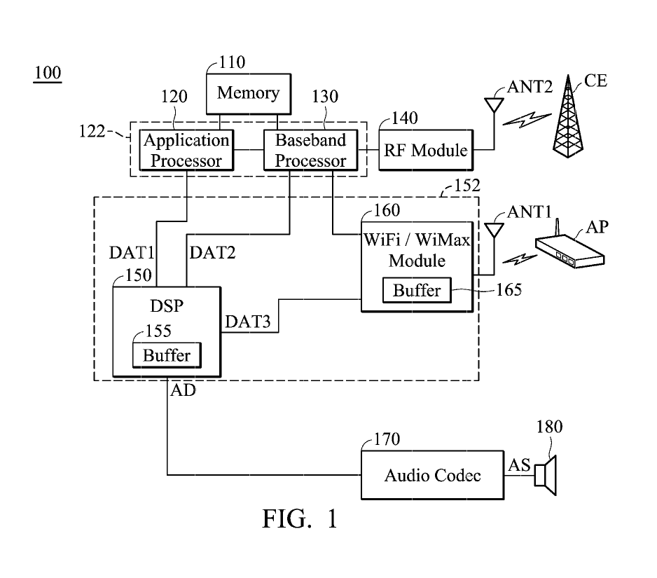

FIG. 1 shows a schematic diagram illustrating a portable electronic device 100 according to an embodiment of the invention. In this embodiment, the portable electronic device 100 may be a smartphone or a tablet PC and comprises a memory 110, an application processor 120, a baseband processor 130, a radio frequency (RF) module 140, a digital signal processor (DSP) 150, a wireless module 160, an audio codec 170 and two antennas ANT1 and ANT2. The memory 110 stores various multimedia data, e.g. audio files (mp3 format), and the application processor 120 is coupled to the memory 110 to access multimedia data. In this embodiment, the application processor 120 and the baseband processor 130 are integrated into a single chip 122. In one embodiment, the memory 110 can be a secure digital (SD) card or a NAND flash memory. Furthermore, the application processor 120 is coupled to the baseband processor 130, and baseband processor 130 is configured to camp on a cell (e.g. a base station) CE via the RF module 140 and the antenna ANT2. The wireless module 160 is coupled to the antenna ANT1. In the embodiment, the wireless module 160 and the DSP 150 are integrated into a wireless communication chip 152, which is physically separated from the chip 122. Furthermore, the wireless module 160 is a WiFi module supporting IEEE 802.11 protocol or a WiMax module supporting IEEE 802.16 protocol (hereinafter WiFi/WiMax module), and the WiFi/WiMax module can link to a remote station (e.g. an access point (AP) or a base station) via the antenna ANT1. The DSP 150 is capable of performing an audio process for the audio data received from the application processor 120, the baseband processor 130 or the wireless module 160. For example, the application processor 120 may read the multimedia data DAT1 stored in the memory 110 and then provide the multimedia data DAT1 to the DSP 150. Next, the DSP 150 performs an audio process for the multimedia data DAT1 and then generates an audio output signal AD according to the audio process for the multimedia data DAT1. In the embodiment, the DSP 150 may encode or decode the multimedia data DAT1 with an encoding/decoding algorithm to generate the audio output signal AD. Next, the audio codec 170 performs a digital to analog converting operation to generate an analog audio signal AS according to the audio output signal AD. In the embodiment, the audio codec 170 may provide the analog audio signal AS to an audio output unit so that the audio output unit can generate an audible sound according to the analog audio signal AS. In one embodiment, the audio codec 170 may amplify and/or filter the audio output signal AD and then generate the analog audio signal AS. In other embodiment, the audio codec 170 may merely filter the audio output signal AD and then output the audio output signal AD, which is digital, to an amplifier (not shown), wherein the amplifier is coupled between the audio codec 170 and the audio output unit for receiving the audio output signal AD from the audio codec 170 and has a digital-analog converter for converting the audio output signal AD into the analog audio signal AS. In the embodiment, the audio output unit may be a speaker 180 of the portable electronic device 100 for receiving the analog audio signal AS and generating an audible sound accordingly. In an alternative embodiment, the audio codec 170 may be integrated with the DSP 150 inside the wireless communication chip 152.

Furthermore, the baseband processor 130 may receive a voice data DAT2 from a base station via the RF module 140 and the antenna ANT2 when a telephone call is established between the portable electronic device 100 and a cell (e.g. a base station) CE, and then the baseband processor 130 provides the voice data DAT2 to the DSP 150. Next, the DSP 150 performs an audio process for the voice data DAT2 and then generates an audio output signal AD according to the audio process for the voice data DAT2. Similarly, the wireless module 160 may obtain an audio stream data DAT3 (e.g. a music file or an IP voice data) from a remote station (e.g. an access point (AP) or a base station) via the antenna ANT1, and then provides the audio stream data DAT3 to the DSP 150. Next, the DSP 150 performs an audio process for the audio stream data DAT3 and generates an audio output signal AD according to the audio process for the audio stream data DAT3.

Furthermore, the wireless module 160 comprises a buffer 165, and the audio stream data DAT3 from the antenna ANT1 can be stored in the buffer 165, and then the application processor 120 or the baseband chip 130 can write the audio stream data DAT3 stored in the buffer 165 into the memory 110. In addition, the DSP 150 further comprises a buffer 155 for storing the receiving data DAT1, DAT2 or DAT3. In the embodiment, the application processor 120 may enter and operate at a sleep mode while the DSP 150 is performing an audio process for the data DAT1, DAT2 or DAT3 and/or the speaker 180 is generating an audible sound according to the data DAT1, DAT2 or DAT3. In this embodiment, when the application processor 120 operates at the sleep mode, no application program, e.g. browser, e-mail, calendar, contact list, game, call, game and so on, is executed, by the application processor 120. Thus, power consumption of the application processor 120 is decreased for the portable electronic device 100. Furthermore, if a capacity of the buffer 155 of the DSP 150 is unable to store the entire multimedia data, the entire multimedia data will be divided into a plurality of data blocks, which are moved to and stored in the buffer 155 one by one and outputted to the audio codec 170 sequentially. For example, when one of the data blocks of the multimedia data in the buffer 155 is outputted from the DSP 150 to the audio codec 170 with the audio output signal AD and, in particular, smaller than a predetermined threshold, the DSP 150 will wake the application processor 120 up (e.g. from the sleep mode to a normal mode), so as to obtain another data block (e.g. a subsequent data block) of the multimedia data from the memory 110 via the application processor 120 to be stored into the buffer 155.

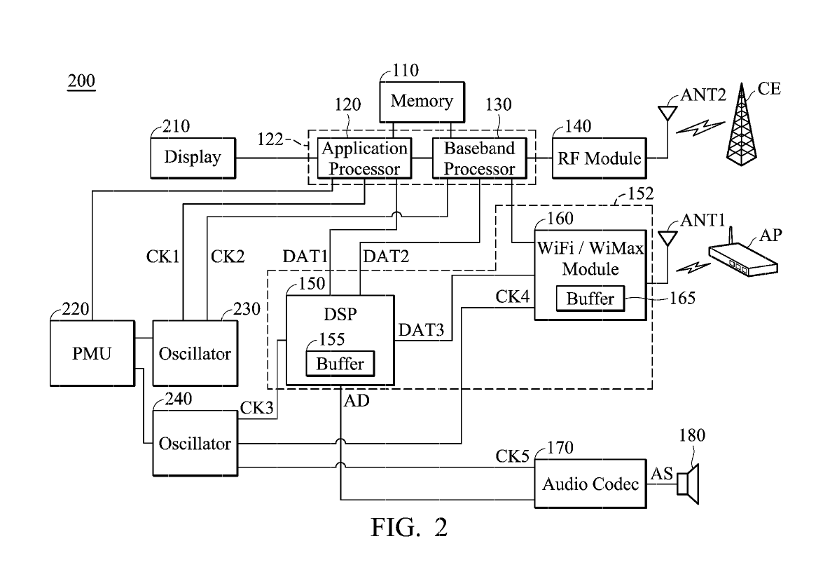

FIG. 2 shows a schematic diagram illustrating a portable electronic device 200 according to another embodiment of the invention. Compared with the portable electronic device 100 of FIG. 1, the portable electronic device 200 further comprises a display 210 coupled to the application processor 120, a power management unit (PMU) 220 and two oscillators 230 and 240. In the portable electronic device 200, the PMU 220 controls the oscillators 230 and 240 to generate various clock signals as the operating clocks for the portable electronic device 200, wherein the clock signals generated by the oscillator 240 are slower than the clock signals generated by the oscillator 230. For example, the oscillator 230 provides a clock signal CK1 to the application processor 120 as an operating clock of the application processor 120, and provides a clock signal CK2 to the baseband processor 130 as an operating clock of the baseband processor 130. Furthermore, the oscillator 240 provides a clock signal CK3 to the DSP 150 as an operating clock of the DSP 150, provides a clock signal CK4 to the wireless module 160 as an operating clock of the wireless module 160, and provides a clock signal CK5 to the audio codec 170 as an operating clock of the audio codec 170. In the embodiment, when the DSP 150 is performing an audio process for the data DAT1, DAT2 or DAT3 and/or the speaker is generating an audible sound according to the audio output signal AD, which is generated further according to the data DAT1, DAT2 or DAT3, the application processor 120 could enter a sleep mode, in which the display 210 is turned off and the oscillator 230 reduces the frequency of the clock signal CK1 or stops providing the clock signal CK1 to the application processor 120. When the application processor 120 enters a sleep mode, the oscillator 240 keeps providing the clock signal CK3 to the DSP 150, so that the DSP 150 could process the data DAT1, DAT2 and DAT3 and generate the audio output signal AD. Simultaneously, the oscillator 240 also keeps providing the clock signal CK5 to the audio codec 170 so that the audio codec 170 could generate the analog audio signal AS and send it to the speaker 180 for generating the audible sound. In this embodiment, the baseband processor 130 may also enter a sleep mode, in which the oscillator 230 reduces the frequency of the clock signal CK2 or stops providing the clock signal CK2 to the baseband processor 130. Accordingly, the portable electronic device 200 could saves more power due to the decrease of the power consumption caused by the application processor 120, the baseband processor 130 and the oscillator 230.

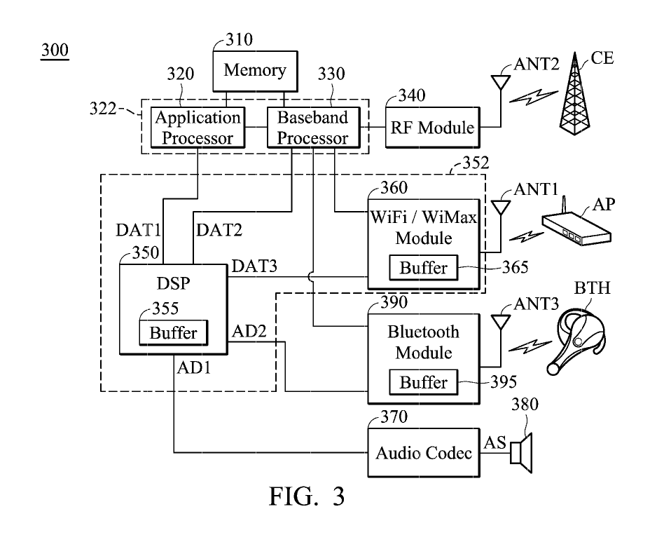

FIG. 3 shows a schematic diagram illustrating a portable electronic device 300 according to another embodiment of the invention. The portable electronic device 300 comprises a memory 310, an application processor 320, a baseband processor 330, a RF module 340, a DSP 350, a wireless module 360, an audio codec 370, a Bluetooth (BT) module 390 and three antennas ANT1, ANT2 and ANT3. In the embodiment, the application processor 320 and the baseband processor 330 are integrated into a single chip 322, and the wireless module 360 and the DSP 350 are integrated into a wireless communication chip 352. Furthermore, the wireless module 360 is a WiFi module supporting IEEE 802.11 protocol or a WiMax module supporting IEEE 802.16 protocol (hereinafter WiFi/WiMax module), and the WiFi/WiMax module can link to a remote station (e.g. an access point (AP) or a base station) via the antenna ANT1. The baseband processor 330 is configured to camp on a cell (e.g. a base station) CE via the RF module 340 and the antenna ANT2. As described above, the memory 310 can store various multimedia data. Furthermore, the memory 310 can be a secure digital (SD) card or a NAND flash. Compared with the portable electronic device 100 of FIG. 1, the portable electronic device 300 comprises two wireless modules (i.e. the wireless module 360 and the BT module 390). In one embodiment, the wireless module 360 and the BT module 390 are implemented in the same wireless communication chip 352. The wireless module 360 is able to link to a remote station (e.g. an AP or a base station) via the antenna ANT1, and the BT module 390 is able to link to a BT device BTH (e.g. a BT headset or a BT speaker) via the antenna ANT3. The DSP 350 is capable of performing an audio process for the multimedia data DAT1 from the application processor 320, the voice data DAT2 from the baseband processor 330 or the audio stream data DAT3 from the wireless module 360. Next, the DSP 350 performs an audio process for the received data DAT1, DAT2 or DAT3 and then generates an audio output signal AD1 to be sent to the audio codec 370 or another audio output signal AD2 to be sent to the BT module 390. For example, in a first mode, an audio stream data DAT3 is downloaded by the wireless module 360 via the antenna ANT1, and the wireless module 360 provides the audio stream data DAT3 to the DSP 350. Next, the DSP 350 processes the audio stream data DAT3 with an encoding/decoding algorithm to generate the audio output signal AD1, and provides the audio output signal AD1 to the audio codec 370. Next, the audio codec 370 converts the audio output signal AD1 into the analog audio signal AS and sends it to a speaker 380 of the portable electronic device 300, so that the speaker 380 generates an audible sound according to the analog audio signal AS. In a second mode, when the wireless module 360 provides the audio stream data DAT3 to the DSP 350, the DSP 350 processes the audio stream data DAT3 with an encoding/decoding algorithm to generate the audio output signal AD2, and then the DSP 350 provides the audio output signal AD2 to the BT module 390. Next, the BT module 390 transmits the audio output signal AD2 to a BT device (e.g. a BT speaker or a BT headset) via the antenna ANT3 so that the BT device could generate an audible sound according to the audio output signal AD2. In the embodiment, the application processor 320 could enter a sleep mode, in which no application program is executed by the application processor 320. Thus, power consumption of the application processor 320 is decreased for the portable electronic device 300. In a third mode, the application processor 320 may read a multimedia data DAT1 stored in the memory 310 or the baseband processor 330 may receive a voice data DAT2 from a base station and then provide the data DAT1 or DAT2 to the DSP 350. When receiving the data DAT1 or DAT2, the DSP 350 may perform an encoding/decoding algorithm to generate the audio output signal AD1, and then the DSP 350 provides the audio output signal AD1 to the audio codec 370. Next, the audio codec 370 converts the audio output signal AD1 into the analog audio signal AS and sends it to a speaker 380 of the portable electronic device 300, so that the speaker 380 generates an audible sound according to the analog audio signal AS. In a fourth mode, when receiving the data DAT1 or DAT2, the DSP 350 performs an encoding/decoding algorithm to generate the audio output signal AD2, and then the DSP 350 provides the audio output signal AD2 to the BT module 390. Next, the BT module 390 transmits the audio output signal AD2 to the BT device via the antenna ANT3 so that the BT device could generate an audible sound according to the audio output signal AD2.

As described above, the DSP 350 comprises a buffer 355 for storing the receiving data DAT1, DAT2 or DAT3. Furthermore, the wireless module 360 comprises a buffer 365 for storing the audio stream data DAT3 from the antenna ANT1, and the application processor 320 or the baseband chip 330 can write the audio stream data DAT3 stored in the buffer 365 into the memory 310. In addition, the BT module 390 comprises a buffer 395 for storing the signal AD2 from the DSP 350, and the application processor 320 or the baseband processor 330 can write the data stored in the buffer 395 into the memory 310. In the embodiment, the application processor 320 and/or the baseband processor 330 may respectively enter a sleep mode while the DSP 350 is performing an audio process for the data DAT1, DAT2 or DAT3 and the speaker 380 or the BT device is generating an audible sound according to the data DAT1, DAT2 or DAT3. Thus, power consumption of the application processor 320 and/or the baseband processor 330 could be decreased for the portable electronic device 300.

Furthermore, in the DSP 350, if a capacity of the buffer 355 of the DSP 350 is unable to store the entire multimedia data, the entire multimedia data will be divided into a plurality of data blocks, which are moved to and stored in the buffer 355 one by one and outputted to the audio codec 370 sequentially. For example, when one of the data blocks of the multimedia data in the buffer 355 is outputted from the DSP 350 to the audio codec 370 with the audio output signal AD1 and, in particular, smaller than a predetermined threshold, the application processor 320 or/and the baseband processor 330 will be awaken by the DSP 350 from the sleep mode to a normal mode, and the buffer 355 could obtain another data block of the multimedia data from the memory 310 via the application processor 320 or the baseband processor 330 to be stored into the buffer 355.

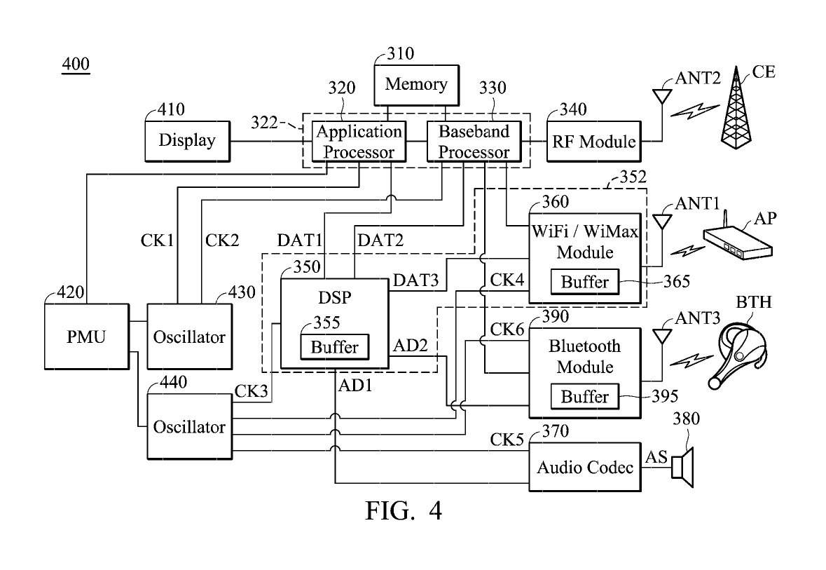

FIG. 4 shows a schematic diagram illustrating a portable electronic device 400 according to another embodiment of the invention. Compared with the portable electronic device 300 of FIG. 3, the portable electronic device 400 further comprises a display 410 coupled to the processor 420, a PMU 420 and two oscillators 430 and 440. In the portable electronic device 400, the PMU 420 controls the oscillators 430 and 440 to generate various clock signals as the operating clocks for the portable electronic device 400, wherein the clock signals generated by the oscillator 440 are slower than the clock signals generated by the oscillator 430. For example, the oscillator 430 provides clock signals CK1 and CK2 to the application processor 420 and the baseband processor 430, respectively. The oscillator 440 provides clock signals CK3, CK4, CK5 and CK6 to the DSP 350, the wireless module 360, the audio codec 370 and the BT module 390. In the embodiment, when the DSP 350 is performing an audio process for the data DAT1, DAT2 or DAT3 and the speaker 380 or the BT device is generating an audible sound, the application processor 320 and the baseband processor 330 could enter a sleep mode, in which the display 410 is turned off and the oscillator 430 reduces the frequencies of the clock signals CK1 and CK2 or stops providing the clock signals CK1 and CK2 to the application processor 320 and the baseband processor 330, respectively. Therefore, the portable electronic device 400 could save more power due to the decrease of the power consumption caused by the application processor 320, the baseband processor 330 and the oscillators 430 and 440.

In the above-mentioned embodiments, the electronic devices 100, 200, 300, 400 may be smartphones or PDA phone. In other embodiments, the electronic devices 100, 200, 300, 400 may be PDAs, tablet PCs, or a wearable electronic devices without any baseband processor. In addition, in FIGS. 1-4, the wireless modules 160 and 360 and the Bluetooth module 390 are electrically connected to the baseband processors 130 and 330; however, they could be electrically connected to the application processors 120 and 320 in other embodiments.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a storage unit configured to store multimedia data;
an application processor coupled to the storage unit and configured to access the multimedia data stored in the storage unit and execute at least one application program;
a first antenna; and
a wireless communication chip comprising a WiFi/WiMax module and a digital signal processor (DSP) integrated thereinto, wherein the WiFi/WiMax module is coupled to the first antenna for wirelessly receiving an audio stream data from a remote station, and the digital signal processor is coupled to the WiFi/WiMax module and the application processor and configured to process the audio stream data from the WiFi/WiMax module or the multimedia data from the application processor and generate an audio output signal according to the processed audio stream data or the processed multimedia data;
wherein the wireless communication chip is configured to output the audio output signal.

2. The portable electronic device as claimed in claim 1, the application processor is further configured to operate at a sleep mode without executing the at least one application program.

3. The portable electronic device as claimed in claim 2, further comprising:
an audio codec coupled to the wireless communication chip for receiving the audio output signal.

4. The portable electronic device as claimed in claim 3, further comprising:
an audio output unit coupled to the audio codec, wherein the audio codec is further configured to convert the received audio output signal into an analog audio signal, and the audio output unit is configured to receive the analog audio signal and generate an audible sound according to the analog audio signal; and wherein when the audio output unit generates the audible sound, the application processor enters the sleep mode.

5. The portable electronic device as claimed in claim 3, further comprising:
an audio output unit and an amplifier, wherein the amplifier is coupled between the audio codec and the audio output unit for receiving the audio output signal from the audio codec and has a digital-analog converter for converting the audio output signal into an analog audio signal, and the audio output unit is configured to receive the analog audio signal and generate an audible sound according to the analog audio signal; and wherein when the audio output unit generates the audible sound, the application processor enters the sleep mode.

6. The portable electronic device as claimed in claim 1, further comprising:
a second antenna; and
a bluetooth module coupled to the second antenna and the digital signal processor for providing the audio output signal to a Bluetooth device via the second antenna.

7. The portable electronic device as claimed in claim 6, wherein the bluetooth module is integrated inside the wireless communication chip.

8. The portable electronic device as claimed in claim 2, wherein the WiFi/WiMax module comprises a first buffer for storing the audio stream data from the first antenna, and the digital signal processor comprises a second buffer for storing the audio stream data from the WiFi/WiMax module or the multimedia data from the storage unit.

9. The portable electronic device as claimed in claim 8, wherein the application processor writes the audio stream data stored in the first buffer into the storage unit.

10. The portable electronic device as claimed in claim 8, wherein the multimedia data is divided into at least one first data block and one second data block; and wherein when the first data block is stored in the second buffer and then outputted by the wireless communication chip with the audio output signal, the DSP wakes the application processor up from the sleep mode and the second buffer obtains the second data block of the multimedia data from the storage unit via the application processor.

11. The portable electronic device as claimed in claim 10, wherein the DSP wakes the application processor up from the sleep mode when the first data block in the second buffer is smaller than a predetermined threshold.

12. The portable electronic device as claimed in claim 4, wherein the audio output unit is a speaker.

13. The portable electronic device as claimed in claim 2, further comprising:
a display coupled to the application processor, wherein the display is turned off when the application processor enters the sleep mode.

14. The portable electronic device as claimed in claim 2, further comprising:
a first oscillator configured to provide a first clock signal to the application processor;
a second oscillator configured to provide a second clock to the DSP;
wherein when the application processor enters the sleep mode, the first oscillator reduces the frequency of the first clock signal or stops providing the first clock signal to the application processor while the second oscillator provides the second clock signal to the DSP for processing the audio stream data or the multimedia data and generating the audio output signal.

15. The portable electronic device as claimed in claim 14, further comprising:
a power management unit coupled to the application processor and the first and the second oscillators, wherein when the application processor enters the sleep mode, the power management unit controls the first oscillator to stop providing the first clock signal to the application processor and controls the second oscillator to provide the second clock signal to the DSP.

16. The portable electronic device as claimed in claim 14, wherein the second clock is slower than the first clock.

17. The portable electronic device as claimed in claim 1, further comprising:
a third antenna; and
a baseband processor coupled to the third antenna for camping on a base station via the third antenna.

18. The portable electronic device as claimed in claim 17, wherein the baseband processor and the application processor are integrated into a single chip, which is physically separated from the wireless communication chip.

19. The portable electronic device as claimed in claim 1, wherein the portable electronic device is a smartphone, a PDA phone, a PDA a tablet PC, or a wearable electronic device.

20. The portable electronic device as claimed in claim 3, wherein the audio codec is integrated with the DSP inside the wireless communication chip.
